(19) United States
(12) Patent Application Publication
(10) Pub. No.: US 2007/0200968 A1
(43) Pub. Date: Aug. 30, 2007

(54) DISPLAY PANEL STRUCTURE FOR IMPROVING ELECTROSTATIC DISCHARGE IMMUNITY

(76) Inventor: Chyh-Yih Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,642

(22) Filed: Apr. 17, 2006

(30) Foreign Application Priority Data
Feb. 24, 2006 (TW) 95106251

(51) Int. Cl. G02F 1/1333

(52) U.S. Cl. 349/54

(57) ABSTRACT

A display panel structure for improving electrostatic discharge (ESD) immunity is provided. The structure includes a first substrate, a pixel-array area, and an ESD protection path. The pixel-array area is disposed on the first substrate. At least one pixel unit and at least one data channel are disposed in the pixel-array area. The ESD protection path surrounds the pixel-array area to conduct an electrostatic current.

### CROSS-REFERENCE TO RELATED APPLICATION

This application claims the priority benefit of Taiwan application serial no. 95106251, filed on Feb. 24, 2006. All disclosure of the Taiwan application is incorporated herein by reference.

### BACKGROUND OF THE INVENTION

1. Field of Invention

The present invention relates to an electrostatic discharge (ESD) protection device. More particularly, the present invention relates to a display panel structure for improving ESD immunity.

2. Description of Related Art

Electronic products are often impacted by electrostatic discharge (ESD) in practical usage environments, and if no proper protective measures are taken, inner elements may be destroyed. In fact, generally, the voltage of ESD is much larger than a common supply voltage. When ESD occurs, an electrostatic current is likely to burn elements. Therefore, the question of how to isolate electrostatic current to avoid damage to elements is of great importance. In order to avoid the aforementioned situation, some ESD protective measures must be taken in circuits. The International Electrotechnical Commission (IEC) has stipulated several protection and testing standards for ESD immunity and electromagnetic compatibility (EMC). For example, “Electromagnetic compatibility—Part 4-1: Testing and measurement techniques—ESD immunity” (generally referred as IEC.61000-4-2 for short) published by IEC in April 2001 is one of the protection and testing standards of electronic products.

FIG. 1 illustrates a conventional ESD protection architecture of a liquid crystal display panel 100 by taking “chip-on-glass” technology as an example. An integrated circuit 120 and a pixel-array area 130 are disposed on a glass substrate 110 in FIG. 1. Herein, the “integrated circuit 120” represents all electric elements disposed on the glass substrate 110 except the elements in the pixel-array area 130, i.e., the “integrated circuit 120” not only represents a single packaged integrated circuit. The pixel-array area 130 has a plurality of pixel units, for example, a pixel unit 131 in the figure is one of them. Each pixel unit is electrically connected to the integrated circuit 120 respectively via a corresponding data channel. Moreover, each pixel unit is further electrically connected to the integrated circuit 120 respectively via a corresponding scan channel, so as to control on-off timing of the pixel units. Therefore, each pixel unit may display images according to control and drive of the integrated circuit 120.

Generally, an ESD protection circuit of the display panel 100 is disposed within the pixel-array area 130. The ESD protection circuit of the conventional art comprises a common wire 132 and a plurality of ESD protection elements 133. Each data channel and each scan channel are coupled to the common wire 132 respectively via the corresponding ESD protection elements 133. When the pixel-array area 130 is impacted due to occurrence of the ESD, the electrostatic current takes each data channel and/or each scan channel as its flow path. At this time, each ESD protection element 133 must be able to be activated in time to conduct most of the electrostatic current to the common wire 132. The electrostatic current is then grounded or conducted to a secondary ESD protection circuit (not shown) by the common wire 132.

U.S. Pat. No. 6,337,722 and U.S. Pat. No. 6,566,902 may be referred to for the aforementioned conventional art. However, in the conventional art, a part of the electrostatic current still impacts each pixel unit, such as the pixel unit 131 and the integrated circuit 120. If the ESD protection element 133 fails to be activated in time, ESD may still destroy the display panel 100.

### SUMMARY OF THE INVENTION

Accordingly, the object of the present invention is directed to provide a display panel structure for improving electrostatic discharge (ESD) immunity.

Based on the aforementioned and other objects, the display panel structure for improving ESD immunity provided by the present invention comprises a first substrate, a pixel-array area, and an ESD protection path. The pixel-array area is disposed on the first substrate. At least one pixel unit and at least one data channel are disposed in the pixel-array area. The ESD protection path surrounds the pixel-array area to conduct the electrostatic current.

According to one preferred embodiment of the present invention, the display panel structure for improving ESD immunity further comprises a plurality of connection pads disposed on the surface of the first substrate to provide a transmission interface between the display panel and the exterior, wherein the aforementioned ESD protection path is electrically connected to at least one of the connection pads.

According to one preferred embodiment of the present invention, the display panel structure for improving ESD immunity further comprises an integrated circuit disposed on the surface of the first substrate, wherein the aforementioned ESD protection path is electrically connected to an ESD protection circuit of the integrated circuit.

In the present invention, since the ESD protection path is disposed around the pixel-array area, when the ESD occurs in the display panel, the impact of the ESD will be isolated by the ESD protection path, so as not to influence the pixel-array area. Thus, the ESD immunity of the display panel is improved.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates the conventional ESD protection architecture of a liquid crystal display panel by taking the “chip-on-glass” technology as an example.

FIG. 2 illustrates an embodiment of the display panel structure for improving ESD immunity according to the present invention.

FIG. 3 illustrates another embodiment of the display panel structure for improving ESD immunity according to the present invention.

FIG. 4 illustrates still another embodiment of the display panel structure for improving ESD immunity according to the present invention.

FIG. 5 illustrates still another embodiment of the display panel structure for improving ESD immunity according to the present invention.

FIG. 6 illustrates yet another embodiment of the display panel structure for improving ESD immunity according to the present invention.

### DESCRIPTION OF EMBODIMENTS

In order to explain the spirit and technical features of the present invention conveniently and clearly, embodiments of the present invention applied in a liquid crystal display panel or a thin film transistor display panel will be illustrated by taking a liquid crystal display panel adopting “chip-on-glass” technology as an example. The range of the application of the present invention should not be limited to the teaching of embodiments described below. The present invention can be applied in display panels of any type and any technique by those skilled in the art according to their requirements.

FIG. 2 illustrates an embodiment of a display panel structure for improving ESD immunity according to the present invention. The display panel 200 includes a first substrate 210, a second substrate 220, an integrated circuit 230, a pixel-array area 240, and an ESD protection path 250. In the present embodiment, the main material of the substrates 210 and 220 is glass plate, wherein the second substrate 220 further functions as a polaroid.

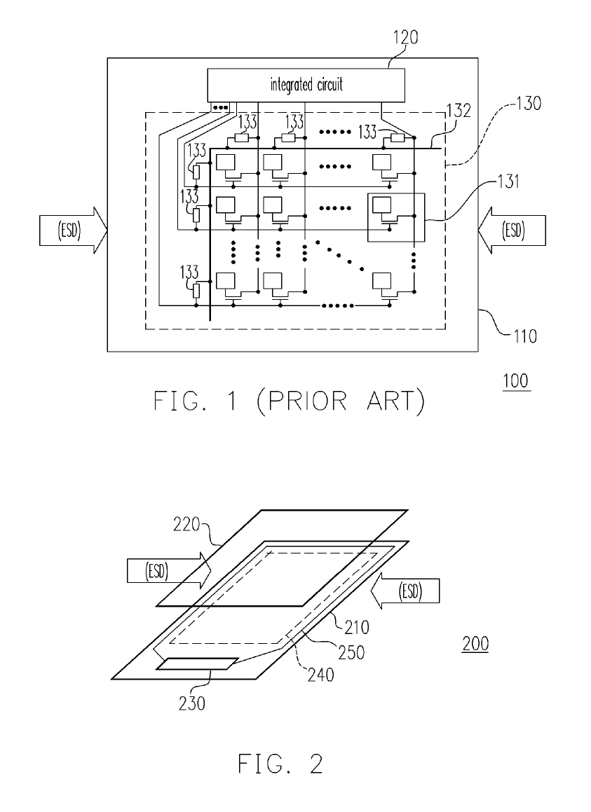

Referring to FIG. 2, the integrated circuit 230, the ESD protection path 250, and the pixel-array area 240 are disposed on the glass substrate 210. Herein, the “integrated circuit 230” represents all the electric elements disposed on the glass substrate 210 except the elements in the pixel-array area 240, i.e., the “integrated circuit 230” not only represents a single packaged integrated circuit. The integrated circuit 230 is electrically connected to the pixel-array area 240 to drive the pixel-array area 240, so as to display images. A plurality of pixel units, data channels, and scan channels are disposed in the pixel-array area 240, as shown in the pixel-array area 130 in FIG. 1. The pixel units, the data channel, and the scan channel are not shown herein and are represented with a dotted line frame 240.

The material of the ESD protection path 250 can be aluminum, aluminum compound, copper, copper compound, indium tin oxide, or other electrical conductor. The ESD protection path 250 is not electrically contacted with the pixel-array area 240. In the present embodiment, the ESD protection path 250 is electrically connected to an ESD protection circuit of the integrated circuit 230. The ESD protection path 250 surrounds the pixel-array area 240 to conduct the electrostatic current. For example, the ESD protection path 250 is disposed on the surface of the first substrate 210 along the edge of the first substrate 210.

When the modular display panel 200 is impacted due to the occurrence of the ESD, the static electricity enters a seam between the outer frame (not shown) of the display panel 200 and the first substrate 210, and then impacts each element on the substrate 210 from the side faces. Since the ESD protection path 250 is disposed along the edge of the substrate 250, the static electricity will be hindered by the ESD protection path 250 and thus other elements will not be destroyed. The electrostatic current on the ESD protection path 250 will then be grounded or conducted to a secondary ESD protection circuit (not shown).

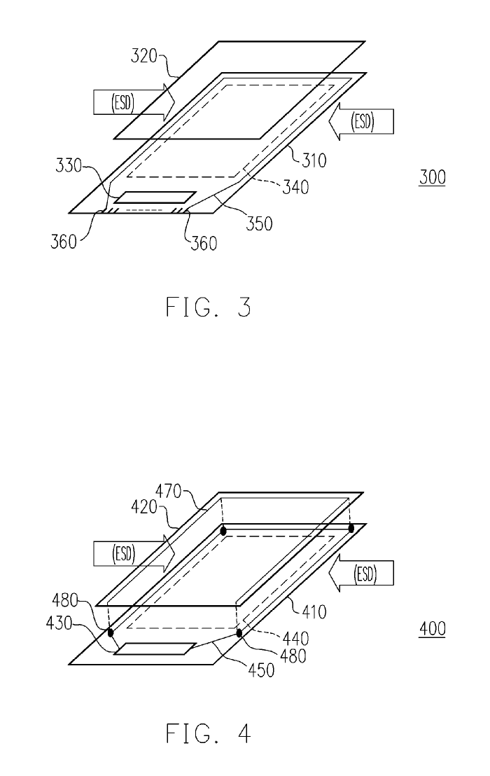

FIG. 3 illustrates another embodiment of the display panel structure for improving ESD immunity according to the present invention. The display panel 300 includes a first substrate 310, a second substrate 320, an integrated circuit 330, a pixel-array area 340, an ESD protection path 350, and a plurality of connection pads 360. In the present embodiment, the substrates 310 and 320, the integrated circuit 330, and the pixel-array area 340 can be the same as the substrates 210 and 220, the integrated circuit 230, and the pixel-array area 240 in FIG. 2 and will not be described any more. The connection pads 360 are disposed on the surface of the first substrate 310 to provide a transmission interface between the display panel 300 and the exterior. The integrated circuit 330 in FIG. 3 is electrically connected between the pixel-array area 340 and each connection pad 360. However, for clear illustration of the embodiment of the present invention, the connection lines between the integrated circuit 330 and each connection pad 360 are not shown in FIG. 3, and neither are the connection lines between the integrated circuit 330 and the pixel-array area 340.

Referring to FIG. 3, in the present embodiment, the ESD protection path 350 is electrically connected to at least one of the connection pads 360. Although the first one and the last one of the connection pads 360 are coupled to the ESD protection path 350, as shown in FIG. 3, different designs can be made by those skilled in the art according to their requirements, for example, the ESD protection path 350 may be electrically connected to a grounding connection pad of the connection pads 360.

The material of the ESD protection path 350 can be any electrical conductor, such as aluminum, aluminum compound, copper, copper compound, or indium tin oxide. In the present embodiment, the pixel-array area 340 and the integrated circuit 330 are not electrically contacted with the ESD protection path 350. In the present embodiment, the ESD protection path 350 is disposed on the surface of the first substrate 310 along the edge of the first substrate 310.

Generally, when the modular display panel 300 is impacted due to the occurrence of the ESD, the static electricity enters the seam between the outer frame (not shown) of the display panel 300 and the first substrate 310, and then impacts each element on the substrate 310 from the side faces. When the modular display panel 300 is impacted due to the occurrence of the ESD, since the integrated circuit 330 and the pixel-array area 340 are surrounded with the ESD protection path 350, the static electricity will be hindered by the ESD protection path 350, and thus other elements will not be destroyed. The electrostatic current on the ESD protection path 350 will then be conducted outside the display panel 300 via the connection pads 360.

Still another embodiment is illustrated according to the spirit of the present invention. FIG. 4 illustrates still another embodiment of the display panel structure for improving ESD immunity according to the present invention. The display panel 400 includes a first substrate 410, a second substrate 420, an integrated circuit 430, a pixel-array area 440, an ESD protection path 450, a second ESD protection path 470, and a plurality of electrical conductors 480. In the present embodiment, the substrates 410 and 420, the integrated circuit 430, the pixel-array area 440, and the ESD protection path 450 can be same as the substrates 210 and 220, the integrated circuit 230, the pixel-array area 240, and the ESD protection path 250 in FIG. 2 and will not be described any more. As shown in FIG. 4, the integrated circuit 430 is electrically connected to the pixel-array area 440. However, for clear illustration of the embodiment of the present invention, the connection lines between the integrated circuit 430 and the pixel-array area 440 are not shown in FIG. 4, and neither is the inner structure of the pixel-array area 440.

Referring to FIG. 4, the second ESD protection path 470 is disposed on the second substrate 420 to conduct the electrostatic current. In the present embodiment, the second ESD protection path 470 is disposed on the surface of the second substrate 420 along the edge of the second substrate 420. The electrical conductors 480 are disposed between the first substrate 410 and the second substrate 420 to make the ESD protection path 450 be electrically connected to the second ESD protection path 470. The material of the aforementioned second ESD protection path 470 can be any electrical conductor, such as aluminum, aluminum compound, copper, copper compound, or indium tin oxide, and the electrical conductors 480 can also be any electrical conductors. In the present embodiment, the pixel-array area 440 is not electrically contacted with the ESD protection paths 450 and 470. When the modular display panel 400 is impacted due to the occurrence of the ESD, since the pixel-array area 440 is surrounded with the ESD protection paths 450 and 470, the static electricity will be hindered by the ESD protection paths 450 and 470 and other elements will thus not be destroyed. The electrostatic current on the ESD protection paths 450 and 470 will then be grounded or conducted to a secondary ESD protection circuit (not shown) via the ESD protection circuit of the integrated circuit 430.

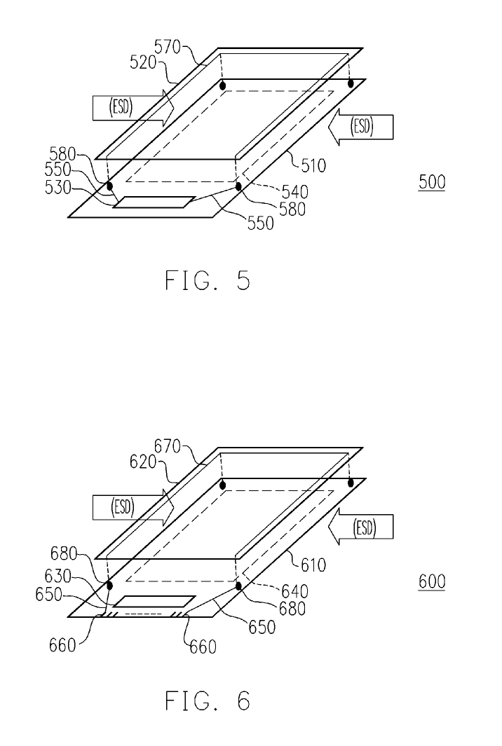

Still another embodiment is illustrated according to the spirit of the present invention. FIG. 5 illustrates still another embodiment of the display panel structure for improving ESD immunity according to the present invention. The display panel 500 includes a first substrate 510, a second substrate 520, an integrated circuit 530, a pixel-array area 540, a first partial path 550 of an ESD protection path, a second partial path 570 of the ESD protection path, and a plurality of electrical conductors 580. In the present embodiment, the substrates 510 and 520, the integrated circuit 530, and the pixel-array area 540 can be the same as the substrates 210 and 220, the integrated circuit 230, and the pixel-array area 240 in FIG. 2 and will not be described any more. The connection lines between the integrated circuit 530 and the pixel-array area 540 are not shown in FIG. 5, and neither is the inner structure of the pixel-array area 540.

The electrical conductors 580 are disposed between the first substrate 510 and the second substrate 520. Different from the display panel 200 in FIG. 2, in the display panel 500, the ESD protection path is not totally disposed on the first substrate 510. Referring to FIG. 5, the first partial path 550 of the ESD protection path is disposed on the first substrate 510, and the second partial path 570 of the ESD protection path is disposed on the second substrate 520. In the present embodiment, the second partial path 570 of the ESD protection path can be disposed on the surface of the second substrate 520 along the edge of the second substrate 520. The first partial path 550 and the second partial path 570 described above can be serially connected with each other through the electrical connection of the electrical conductors 580, thus forming the ESD protection path. The material of the first partial path 550 and the second partial path 570 of the ESD protection path described above can be any electrical conductor, such as aluminum, aluminum compound, copper, copper compound, or indium tin oxide, and the electrical conductors 580 can also be any electrical conductors.

Referring to FIG. 5, in the present embodiment, the pixel-array area 540 is not electrically contacted with the ESD protection paths 550 and 570. When the modular display panel 500 is impacted due to the occurrence of the ESD, since the pixel-array area 540 is surrounded with the ESD protection paths 550 and 570, the static electricity will be hindered by the ESD protection paths 550 and 570 and thus other elements will not be destroyed. The electrostatic current on the ESD protection paths 550 and 570 will then be grounded or conducted to a secondary ESD protection circuit (not shown) via the ESD protection circuit of the integrated circuit 530.

FIG. 6 illustrates yet another embodiment of the display panel structure for improving ESD immunity according to the present invention. The display panel 600 includes a first substrate 610, a second substrate 620, an integrated circuit 630, a pixel-array area 640, a first partial path 650 of an ESD protection path, a second partial path 670 of the ESD protection path, a plurality of connection pads 660, and a plurality of electrical conductors 680. In the present embodiment, the substrates 610 and 620, the integrated circuit 630, the pixel-array area 640, the second partial path 670 of the ESD protection path, and the electrical conductors 680 can be the same as the substrates 510 and 520, the integrated circuit 530, the pixel-array area 540, the second partial path 570 of the ESD protection path, and the electrical conductors 580 in FIG. 5 and will not be described any more.

Different from the display panel 500 in FIG. 5, in the display panel 600, the connection pads 660 are further disposed on the surface of the first substrate 610 to provide a transmission interface between the display panel 600 and the exterior. Referring to FIG. 6, the integrated circuit 630 is electrically connected between the pixel-array area 640 and each connection pad 660. However, for clear illustration of the embodiment of the present invention, the connection lines between the integrated circuit 630 and each connection pad 660 are not shown in FIG. 6, and neither are the connection lines between the integrated circuit 630 and the pixel-array area 640.

In the present embodiment, the first partial path 650 of the ESD protection path is electrically connected to at least one of the connection pads 660. Although the first one and the last one of the connection pads 660 are coupled to the first partial path 650 of the ESD protection path as shown in FIG. 6, different designs can be made by those skilled in the art according to their requirements, for example, the first partial path 650 of the ESD protection path can be electrically connected to a grounding connection pad of the connection pads 660.

Referring to FIG. 6, in the present embodiment, the pixel-array area 640 and the integrated circuit 630 are not electrically contacted with the ESD protection paths 650 and 670. When the modular display panel 600 is impacted due to the occurrence of the ESD, since the pixel-array area 640 and the integrated circuit 630 are surrounded with the ESD protection paths 650 and 670, the static electricity will be hindered by the ESD protection paths 650 and 670 and thus other elements will not be destroyed. The electrostatic current on the ESD protection paths 650 and 670 will then be conducted outside the display panel 600 via the connection pads 660.

In view of the above, in the present invention, since the ESD protection path is disposed around the pixel-array area, when the ESD occurs in the display panel, the impact of the ESD will be hindered by the ESD protection path, so as not to influence the pixel-array area. Thus, the ESD immunity of the display panel is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display panel structure for improving electrostatic discharge (ESD) immunity, comprising:
a first substrate;
a pixel-array area, disposed on the first substrate, wherein at least one pixel unit and at least one data channel are disposed in the pixel-array area; and
an ESD protection path, surrounding the pixel-array area to conduct an electrostatic current.

2. The display panel structure for improving ESD immunity as claimed in claim 1, wherein the ESD protection path is disposed on the surface of the first substrate, and the partial paths of the ESD protection path are disposed on at least one edge of the first substrate.

3. The display panel structure for improving ESD immunity as claimed in claim 1, further comprising:
a second substrate, disposed above the first substrate;
a second ESD protection path, disposed along the edge of the second substrate to conduct the electrostatic current; and
an electrical conductor, disposed between the first substrate and the second substrate to make the ESD protection path be electrically connected to the second ESD protection path.

4. The display panel structure for improving ESD immunity as claimed in claim 3, wherein the second substrate is a polaroid.

5. The display panel structure for improving ESD immunity as claimed in claim 1, further comprising:
a second substrate, disposed above the first substrate; and
at least one electrical conductor, disposed between the first substrate and the second substrate;
wherein a first partial path of the ESD protection path is disposed on the first substrate, while a second partial path of the ESD protection path is disposed on the second substrate, and the first partial path and the second partial path described above are serially connected via the electrical conductor to form the ESD protection path.

6. The display panel structure for improving ESD immunity as claimed in claim 5, wherein the second substrate is a polaroid.

7. The display panel structure for improving ESD immunity as claimed in claim 1, further comprising:
a plurality of connection pads, disposed on the surface of the first substrate to provide a transmission interface between the display panel and the exterior;
wherein the ESD protection path is electrically connected to at least one of the connection pads.

8. The display panel structure for improving ESD immunity as claimed in claim 1, further comprising:
an integrated circuit, disposed on the surface of the first substrate;
wherein the ESD protection path is electrically connected to an ESD protection circuit of the integrated circuit.

9. The display panel structure for improving ESD immunity as claimed in claim 8, wherein the integrated circuit is further electrically connected to the pixel-array area to drive the pixel-array area, so as to display images.

10. The display panel structure for improving ESD immunity as claimed in claim 1, wherein the ESD protection path is an electrical conductor.

11. The display panel structure for improving ESD immunity as claimed in claim 1, wherein the material of the ESD protection path includes aluminum, aluminum compound, copper, copper compound, and/or indium tin oxide.

12. The display panel structure for improving ESD immunity as claimed in claim 1, wherein the ESD protection path is not electrically contacted with the pixel-array area.

13. The display panel structure for improving ESD immunity as claimed in claim 1, wherein the first substrate is a glass plate.

14. The display panel structure for improving ESD immunity as claimed in claim 1, wherein the display panel includes a liquid crystal display panel.

15. The display panel structure for improving ESD immunity as claimed in claim 1, wherein the display panel includes a thin film transistor display panel.
